(19) United States
(12) Patent Application Publication
(10) Pub. No.: US 2014/0050977 A1
(43) Pub. Date: Feb. 20, 2014

(54) METHOD OF AND APPARATUS FOR MANUFACTURING ELECTRODE FOR LITHIUM-ION SECONDARY BATTERY AND ELECTRODE FOR LITHIUM-ION SECONDARY BATTERY

(71) Applicant: DAINIPPON SCREEN MFG. CO., LTD., Kyoto (JP)

(72) Inventors: Masakazu SANADA, Kyoto (JP); Takeshi MATSUDA, Kyoto (JP); Akira IZUMI, Kyoto (JP)

(73) Assignee: DAINIPPON SCREEN MFG. CO., LTD., Kyoto (JP)

(21) Appl. No.: 13/887,689

(22) Filed: May 6, 2013

(30) Foreign Application Priority Data
Aug. 20, 2012 (JP) 2012-181527
Aug. 20, 2012 (JP) 2012-181528

(51) Int. Cl. H01M 4/04; H01M 10/058

(52) U.S. Cl. CPC H01M 4/04; H01M 10/058
USPC 429/211; 29/623.1; 29/730

(57) ABSTRACT

An electrode for lithium-ion secondary battery comprises: a base member which functions as a current collector; and an active material layer formed in a surface of the base member as a stripe-like pattern including a plurality of active material lines which contain silicon or a silicon compound as an active material, which are spaced apart from each other and which protrude beyond the surface of the base member.

### CROSS REFERENCE TO RELATED APPLICATION

The disclosure of Japanese Patent Applications enumerated below including specifications, drawings and claims is incorporated herein by reference in its entirety:

No. 2012-181527 filed on Aug. 20, 2012; and

No. 2012-181528 filed on Aug. 20, 2012.

### BACKGROUND OF THE INVENTION

1. Field of the Invention

The present invention relates to a structure of an electrode which is suitable to a lithium-ion secondary battery and a technique for manufacturing the electrode.

2. Description of the Related Art

Among electrodes for lithium-ion secondary battery and in particular among negative electrodes, those which have already been commercially available use a carbon material such as graphite as an active material, considering physical property values including an electrode potential and an energy density. Over the recent years, studies have been made to use a material which has a greater charge-discharge capacity per unit mass and per unit volume than a carbon material as an active material, silicon or a silicon compound for instance. However, those studies have not yet seen actual application for commercial use since an active material containing silicon greatly changes its volume during occlusion and release of lithium shortens the lifetime (cycle characteristic) when applied particularly to secondary batteries.

A structure of a secondary battery using a silicon-containing active material is described in JP2012-038737A (Patent Document 1) for example. According to the Patent Document 1, an amorphous silicon thin film having column-like structures is formed by RF sputtering on the surface of a copper foil which functions as a current collector, and the resulting structure is used as a negative electrode.

The Patent Document 1 describes that breaks formed in the active material film mitigate stress which is created by expansion and contraction during charge-discharge cycles, which suppresses detachment of the active material film and improves the cycle characteristic of the electrode. However, according to the conventional technique mentioned above, it is to be noted that the column-like structures are obtained by creating breaks in thin portions which are formed in the active material film due to the unevenness of the surface of the current collector film. Hence there is a problem that the structure of the resultant active material film depends upon the condition of the surface of the current collector film during creation of the film and the performance is not reproducible or stable.

No technique has thus been established for manufacturing a battery electrode which performs excellently and stably using an active material such as a silicon-containing material whose volume largely changes during charge-discharge cycles.

### SUMMARY OF THE INVENTION

The invention was made in light of the problem described above, and therefore, an object of the invention is to provide an electrode for lithium ion secondary battery which performs excellently and stably even when an active material which greatly changes its volume during charge-discharge cycles is used and to provide a technique for manufacturing the electrode.

One aspect of the method of manufacturing an electrode for lithium-ion secondary battery according to the present invention comprises the steps of: arranging a nozzle unit in which a plurality of outlets are formed in a row along a predetermined arrangement direction and a base material which functions as a current collector in such a manner that each outlet is opposed to and in a vicinity of a surface of the base material; and discharging an application liquid containing particles of silicon or a silicon compound serving as an active material from each outlet while moving the nozzle unit relative to the base material along the surface of the base material in a direction which intersects the arrangement direction of the outlets, thereby forming within the surface of the base material a stripe-like active material pattern including a plurality of active material lines which are spaced apart from each other and protrude beyond the surface of the base material.

One aspect of the electrode for lithium-ion secondary battery according to the present invention comprises: a base member which functions as a current collector; and an active material layer formed in a surface of the base member as a stripe-like pattern including a plurality of active material lines which contain silicon or a silicon compound as an active material, which are spaced apart from each other and which protrude beyond the surface of the base member.

One aspect of the apparatus for manufacturing an electrode for lithium-ion secondary battery according to the present invention comprises: a nozzle unit in which a plurality of outlets are formed in a row along a predetermined arrangement direction and which continuously discharges from each outlet an application liquid which contains particles of silicon or a silicon compound as an active material; a holder which holds a base material serving as a current collector in a condition that each outlet is opposed to and in a vicinity of a surface of the base material; and a mover which moves the nozzle unit and the base material relative to each other such that the outlets move along the surface of the base material.

In this structure according to the invention, the spaces between the plurality of active material lines have a function of accepting the active material which temporarily expands due to charging. This mitigates stress applied upon the active material due to the expansion-contraction cycles, suppresses destruction of the active material lines which could cause a decrease of the capacity, and makes it possible to obtain an electrode for battery which has an excellent charge-discharge cycle characteristic and a long lifetime. Further, use of silicon or a silicon compound as the active material allows to effectively suppress destruction of the active material lines owing to expansion and contraction of the active material during charge-discharge cycles while attaining a high charge-discharge capacity, and hence, to obtain an electrode for lithium-ion secondary battery which exhibits an excellent charge-discharge cycle characteristic.

Another aspect of the method of manufacturing an electrode for lithium-ion secondary battery according to the present invention comprises the steps of: arranging a nozzle unit in which a plurality of outlets are formed in a row along a predetermined arrangement direction and a base material which functions as a current collector in such a manner that each outlet is opposed to and in a vicinity of a surface of the base material; and discharging an application liquid containing an active material from each outlet while moving the nozzle unit relative to the base material along the surface of the base material in a direction which intersects the arrangement direction of the outlets, thereby forming within the surface of the base material a stripe-like active material pattern including a plurality of active material lines which are spaced apart from each other and protrude beyond the surface of the base material.

Another aspect of the electrode for lithium-ion secondary battery according to the present invention comprises: a base member which functions as a current collector; and an active material layer formed in a surface of the base member as a stripe-like pattern including a plurality of active material lines which contain silicon or a silicon compound as an active material, which are spaced apart from each other and which protrude beyond the surface of the base member.

Another aspect of the apparatus for manufacturing an electrode for lithium-ion secondary battery according to the present invention comprises: a nozzle unit in which a plurality of outlets are formed in a row along a predetermined arrangement direction and which continuously discharges from each outlet an application liquid which contains an active material; a holder which holds a base material serving as a current collector in a condition that each outlet is opposed to and in a vicinity of a surface of the base material; and a mover which moves the nozzle unit and the base material relative to each other such that the outlets move along the surface of the base material.

In these aspects of the present invention, a relationship below is satisfied:

S/W≧n²/20

where the symbol W denotes a width of the active material lines at a half height which is half a height of apices of the active material lines measured from the surface of the base material, the symbol S denotes a gap between neighboring active material lines at the half height, and the symbol n denotes a coefficient of expansion which is defined as a ratio of a width of the active material lines at the half height in charged state to a width of the active material lines at the half height in uncharged state.

As described in detail later, it was discovered that it was possible to discourage a decrease of the capacity caused by repeated charging and discharging to an extremely small decrease when the width W of the active material lines, the gap S and the coefficient of expansion n were combined so as to satisfy the condition above. In other words, as the stripe-like active material lines satisfying the relationship above are formed on the surface of the base material, even when an active material which largely changes its volume in charge-discharge cycles is used, it is possible to obtain an electrode for lithium-ion secondary battery which performs excellently and stably.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIGS. 1A and 1B are drawings which show an example of the structure of a battery which is manufactured utilizing the invention.

FIGS. 2A through 2C are schematic drawings which show the process of manufacturing the negative electrode.

FIGS. 3A through 3D are drawings which show the relationship of dimensions between the outlets and the active material lines.

FIGS. 4A through 4C are drawings for describing the definition of the coefficient of expansion.

FIG. 5 is a drawing which shows some examples of the relationship between the compositions of the active material patterns and the coefficients of expansion.

FIG. 6 is a drawing which shows an example of changes in the discharge capacity during charge-discharge cycles.

FIGS. 7A through 7C are drawings which show examples of test results.

FIG. 8 is a flow chart which shows an embodiment of the electrode manufacturing process.

FIG. 9 is a drawing which shows other example of the structure of the electrode manufacturing apparatus.

### DETAILED DESCRIPTION OF THE PREFERRED EMBODIMENTS

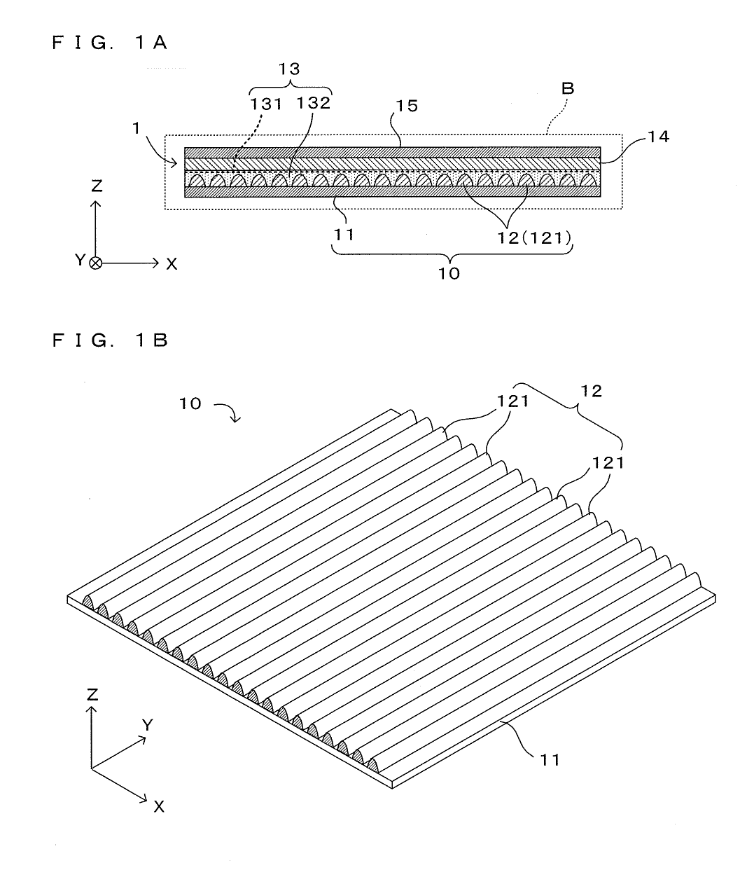

FIGS. 1A and 1B are drawings which show an example of the structure of a battery which is manufactured utilizing the invention. To be more specific, FIG. 1A is a schematic diagram which shows the cross-sectional structure of a lithium-ion secondary battery module in which an electrode for lithium-ion secondary battery according to an embodiment of the invention is used as a negative electrode. FIG. 1B is a perspective drawing of the negative electrode. This lithium-ion secondary battery module 1 has a multi-layer structure that an negative active material layer 12 which is on a negative current collector 11, an electrolyte layer 13 which includes a separator 131 and an electrolyte liquid 132, a positive active material layer 14 and a positive current collector 15 are laminated one atop the other. The directions of the X-, the Y- and the Z-coordinates are defined as shown in FIG. 1A.

FIG. 1B shows the structure of the negative electrode 10 which is obtained by forming the negative active material layer 12 on the surface of the negative current collector 11. As shown in FIG. 1B, the negative active material layer 12 has a line-and-space structure that a plurality of stripe-shaped lines 121 extending in the Y-direction are lined up side by side at constant intervals in the X-direction.

Meanwhile, the positive electrode has a structure that the positive active material layer 14 is approximately uniformly provided on the surface of the positive current collector 15. The positive electrode and the negative electrode 10 which have the structures described above are joined to each other via a separator 131 in such a manner that the active material layers of the electrodes are positioned inwardly, and the gap between the electrodes is impregnated with the electrolyte liquid 132, whereby the lithium-ion secondary battery module 1 is obtained. A tab electrode is disposed to the lithium-ion secondary battery module 1 and a plurality of modules are connected as needed, whereby a lithium-ion secondary battery B is formed.

With respect to materials for forming the respective layers of the lithium-ion secondary battery module 1, an aluminum foil and a copper foil may for instance be used respectively as the positive current collector 15 and the negative current collector 11. For the positive active material layer 14, a known positive active material such as LiCoO₂, LiMnO₂ or a mixture of these may be used. A polypropylene (PP) sheet may for example be used as the separator 131. As the electrolyte fluid 132, for example, a mixture of ethylene carbonate and diethyl carbonate (EC/DEC) containing lithium salt as supporting electrolyte, lithium hexafluorophosphates (LiPF₆) e.g., may be used. The materials of the respective functional layers are not limited to this.

The negative active material layer 12 may for example be of single-crystal silicon particles, amorphous silicon particles, or a silicon compound such as SiO and SiOC. Lithium-ion secondary batteries which have been commercially available use a carbon material such as graphite as the negative active material. However, a silicon-containing active material has a higher specific capacity than a carbon-containing active material (Single-crystal silicon typically has a specific capacity of approximately 4000 mAh/g, whereas graphite has a specific capacity of approximately 370 mAh/g.), and therefore, it is possible to make a battery which has a larger charge-discharge capacity.

A material like a silicon-containing active material which creates alloy with lithium and accordingly acts as a negative active material greatly changes its volume during occlusion-release cycles of lithium ions in accordance with charging and discharging. For this reason, as expansion-contraction is repeated during charge-discharge cycles, the active material layer gets further destroyed or peeled off from the current collector layer so that the capacity gradually decreases. In short, when a material whose volume changes greatly due to charge-discharge is used as an active material, the charge-discharge cycle characteristic of the electrode may become a problem.

Noting this, according to the embodiment, the negative active material layer 12 having the line-and-space structure is formed as shown in FIG. 1B so that the spaces created between the plurality of lines 121 of the stripe-like pattern absorb volume changes of the negative active material. That is, as the active material lines 121 are shaped like stripes which extend in a uniaxial direction, it is possible to suppress expansion of the active material lines 121 in random directions and limit the direction of expansion to the orthogonal direction to the direction in which the lines extend. As the gaps are created in the direction of expansion of the lines, it is possible to mitigate stress upon the lines because of expansion and prevent destruction and delamination of the lines.

One way of forming such a stripe-like pattern is to apply as stripes a paste-like application liquid containing an active material onto the surface of the negative current collector 11 and harden the liquid. A process for manufacturing the negative electrode using such application technique will now be described.

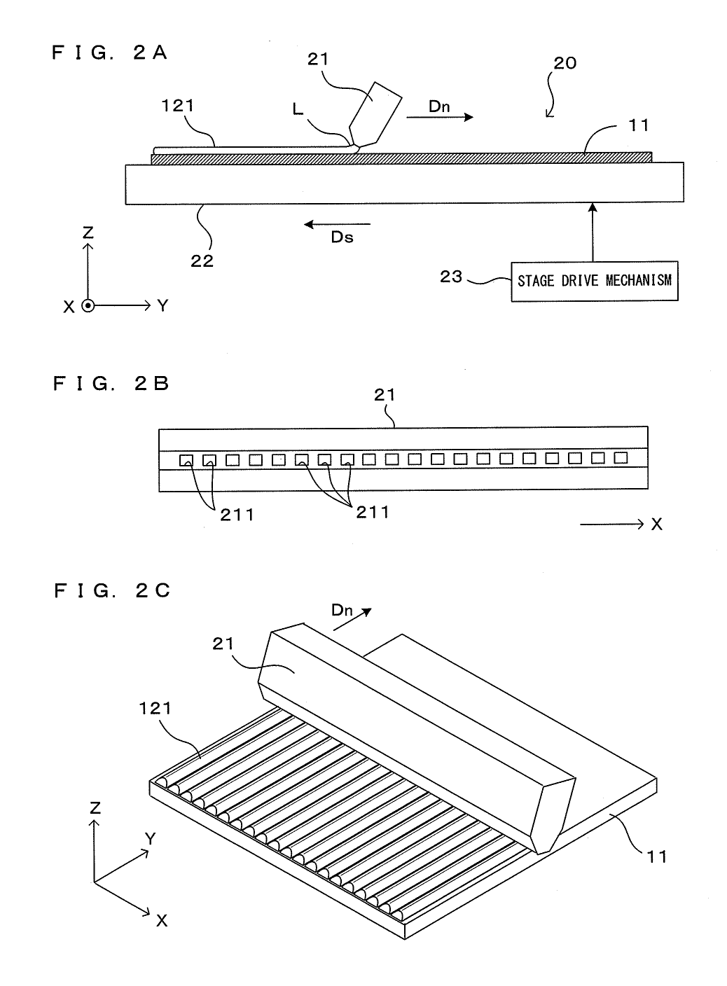

FIGS. 2A through 2C are schematic drawings which show the process of manufacturing the negative electrode. To be more specific, FIG. 2A shows a principal structure of an example of an electrode manufacturing apparatus 20 for manufacturing the negative electrode 10, and FIG. 2B shows the arrangement of outlets 211 at the lower surface of a nozzle unit 21. FIG. 2C is a perspective view which shows the process of manufacturing the negative electrode using the electrode manufacturing

It is possible to form the negative active material layer 12 having the above line-and-space structure as the nozzle unit 21 which continuously discharges an application liquid L containing the negative active material is positioned opposite and close to the surface of the negative current collector 11 and the nozzle unit 21 and the negative current collector 11 move relative to each other as show in FIG. 2A. To be more specific, the electrode manufacturing apparatus 20 comprises a movable stage 22 whose top surface is an approximately flat mounting surface which can seat the negative current collector 11. When driven by a stage drive mechanism 23, the movable stage 22 can move horizontally in the Y-direction. Above the negative current collector 11 which is on the top surface of the movable stage 22, as shown in FIG. 2B, the nozzle unit 21 whose bottom surface includes the plurality of outlets 211 in the X-direction is disposed. The outlets 211 formed in the bottom surface of the nozzle unit 21 are opposed to and in the proximity of the surface of the negative current collector 11. Inside the nozzle unit 21, the paste-like application liquid containing the negative active material is stored.

The application liquid may be obtained by mixing and kneading polyvinylidene fluoride (PVDF) or polyamide-imide for instance which serves as a binder and N-methylpyrrolidone (NMP) for example which acts as a solvent to the negative active material described earlier, and by properly adjusting the viscosity of the mixture. Further, a conductive additive such as acetylene back and carbon black may be added as described in detail later.

When the stage drive mechanism 23 moves the movable stage 22, the negative current collector 11 and the nozzle unit 21 move relative to each other. In short, as the movable stage 22 moves toward the direction of the arrow Ds, the nozzle unit 21 relatively moves in the direction of the arrow Dn along the surface of the negative current collector 11. The application liquid L from the outlets 211 is applied to the negative current collector 11 while the negative current collector 11 and the nozzle unit 12 move relative to each other, a number of active material lines 121 which are parallel to each other along the nozzle movement direction Dn are formed in the surface of the negative current collector 11. Thus, the stripe-like pattern of the negative active material is formed.

The application method as that described above is the so-called nozzle scan method. A technique for application a base material with an application liquid by the nozzle scan method has been known. Since such a known technique can be used with the method above, the structure of the apparatus will not be described in detail.

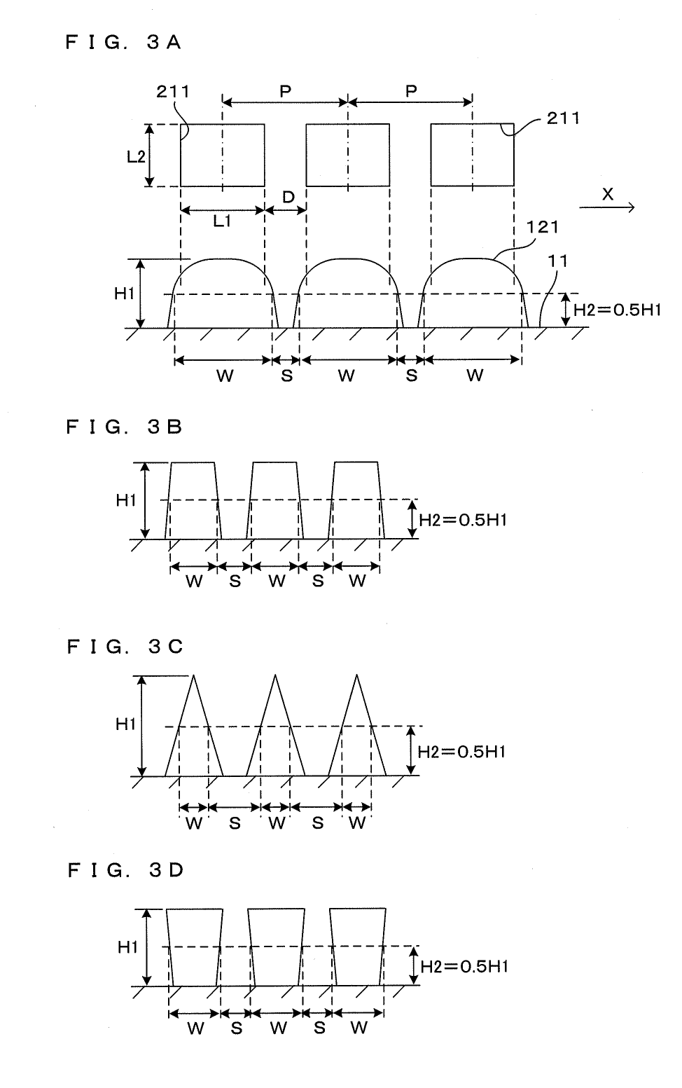

FIGS. 3A through 3D are drawings which show the relationship of dimensions between the outlets and the active material lines. To be more specific, FIG. 3A is a drawing which shows the relationship between the dimensions of the outlets 211 and the cross sectional shape of the lines 121. FIGS. 3B, 3C and 3D are drawings which show other examples of the cross sectional shape of the lines. As shown in FIG. 3A, the plurality of outlets 211 provided in the bottom surface of the nozzle unit 21 all have the same shape of opening and the same dimensions. Describing more particularly, each outlet 211 has a rectangular shape of opening in which the length of opening taken in the X-direction is L1 and the length of opening taken in the orthogonal direction to the X-direction is L2, and the outlets 211 are arranged equidistantly (the arrangement pitch P) in a row along the X-direction. One example of the dimensions is L1=40 μm, L2=30 μm and P=60 μm, in which case the gap D between the outlets 211 in the X-direction is 20 μm.

It is considered that when the application liquid is very viscous, the cross sectional shape of the active material lines 121 which are formed in the surface of the negative current collector 11 as the application liquid is discharged from the outlets 211 which have such dimensions is approximately the same as the shape of opening of the outlets 211. However, it is not easy to extrude such a highly viscous application liquid and form the lines in an effort to strictly maintain the cross sectional shape. It is more practical to use an application liquid which is fluid (i.e., less viscous) to a certain extent.

When such a fluid application liquid is discharged from the outlets 211 and applied upon the negative current collector 11, the active material lines 121 are formed wider than the opening width L1 of the outlets 211 on the negative current collector 11 as shown in FIG. 3A. Further, sections corresponding to the corners of the rectangular shape of the outlets 211 become round. As the width of the active material lines 121 is wide, the gap between the neighboring active material lines 121 become slightly narrower than the gap between the neighboring outlets 211.

Considering that the cross sectional shape of the active material lines 121 does not necessarily become rectangular, the width of the active material lines 121 and the gap between them is defined as below. Where the height from the surface of the negative current collector 11 to the apices of the active material lines 121 is H1, a line width W denotes the dimension of the lines 121 in the X-direction at the height H2 which is half the height H1, i.e., at the height 0.5H1 from the surface of the negative current collector 11 and a line gap S denotes the distance between the neighboring lines in the X-direction at the height H2. These are defined as the dimensions in the uncharged state.

As described above, due to the fluidity of the application liquid, the width W of the lines which are formed becomes wider than the width L1 of the outlets 211 while the line gap S becomes narrower than the gap D between the outlets 211. This works to an advantage when it is desired to form the active material lines 121 at narrow intervals. To achieve a large capacity as an electrode, the amount of the active material carried on the surface of the negative current collector needs be large, and for this purpose, it is preferable that the stripe-like pattern in which a great number of lines are arranged at narrow intervals are formed. Meanwhile, narrowing of the gap D between the plurality of outlets 211 in the nozzle unit 21 reduces the thickness of the member which forms the side walls of the outlets 211 and hence gives rise to a problem that the strength in the vicinity of the outlets 211 decreases.

When the application liquid is allowed to spread sideways after discharged and the line width W is accordingly increased, it is possible to ensure that the gap D between the outlets 211 exceeds the designed line gap S. This makes it possible to avoid deterioration of the strength mentioned above. It is necessary to accurately control the application liquid applying conditions such as the viscosity of the application liquid, the shape of the outlets 211, the amount of the application liquid and the relative speed of the nozzle unit 21 to the negative current collector 11 in order to attain the line width W and the gap S as designed. The application techniques using the nozzle scan method have been proven to adequately satisfy this requirement. For instance, using the nozzle unit 21 which has the dimensions according to the example described above, it is possible to form the active material lines having the line height H1=20 μm, the line width W=50 μm and the line gap S=10 μm. In contrast, it is hardly recognized that the prior art described earlier (JP2012-038737A) has established a technique for forming, spaces for absorbing expansion of an active material in a planned and controlled fashion inside a layer of the active material.

The cross sectional shape of the active material lines is not limited to the shape above but may be various shapes depending upon the shape of opening of the outlets, the viscosity of the application liquid, etc. FIGS. 3B through 3D show some of such examples. FIG. 3B shows an example of the active material lines which are trapezoidal in cross section. FIG. 3C shows an example of the active material lines which are triangular in cross section. FIG. 3D shows an example of the active material lines which look like inversed trapezoids in cross section. Further, in each one of these examples, the corners may be round. As shown in FIGS. 3B through 3D, with respect to these lines whose shape may be any desired shape, it is possible to define the line width W and the line gap S respectively as the dimension of and the gap between the lines at half the height of the line height.

As described earlier, in case of an active material which creates alloy and accordingly occludes lithium such as silicon, the volume of a layer of the active material changes greatly during charge-discharge cycles. The active material layer 12 according to this embodiment is formed by the active material lines 121 which are shaped as stripes, and therefore, a dimensional change of the active material line is suppressed in the longitudinal direction of the active material layer and expansion of the material owing to charging appears as bulging of the cross sectional shape. As expansion is restricted by the separator 131 and the opposite electrode particularly at the apices of the active material lines 121, the cross section bulges sideways in principle. This will be defined as below using a coefficient of expansion n as a parameter which quantitatively denotes the extent of expansion of the active material lines 121.

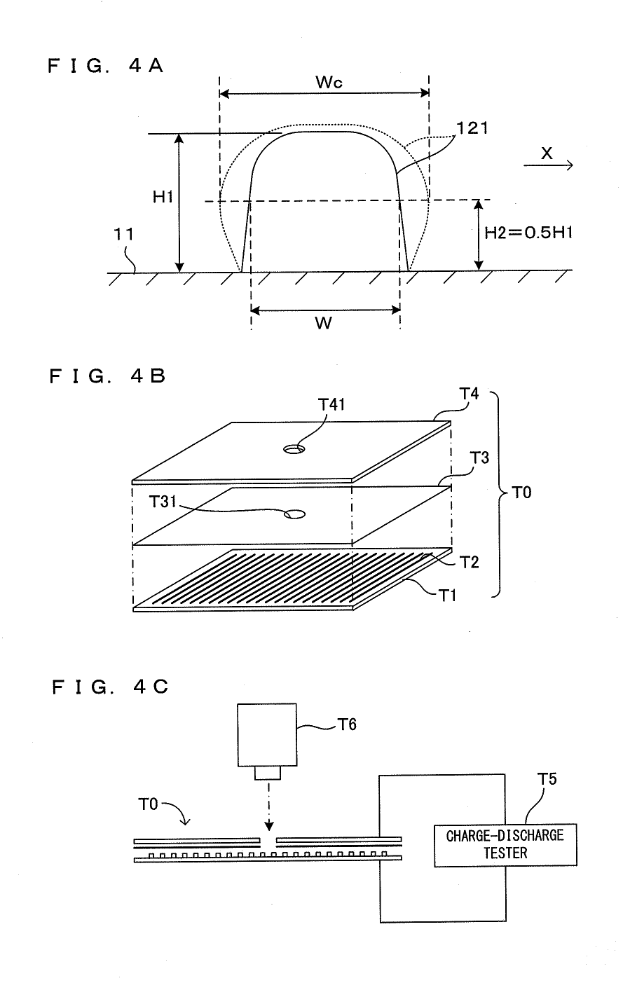

FIGS. 4A through 4C are drawings for describing the definition of the coefficient of expansion. In the case of the active material line 121 shown in FIG. 4A, the cross sectional shape before charging (or in the uncharged state) is denoted at the solid line and the cross sectional shape in the charged state is denoted at the dotted line. From the definition given earlier, the width W of the line 121 in the uncharged state can be denoted by the line dimension at the height H2 which is half the line height H1. The width Wc of the line 121 in the charged state will now be denoted by the line dimension at the height H2. The line width in the charged state to the line width in the discharged state, namely, a value n expressed by the following formula:

n=Wc/W (Formula 1)

is hereinafter defined as the coefficient of expansion of this line. The coefficient of expansion n is a value which is dependent upon the composition of the active material layer.

The coefficient of expansion n can be measured in the following manner. As shown in FIG. 4B, a metallic foil current collector T1 which seats stripe-shaped active material lines T2 which need be measured, a separator T3 and a lithium metallic foil T4 are laminated one atop the other and impregnated with an electrolyte liquid (not shown), thereby obtaining a test piece T0. Small observation holes T31 and T41 are formed respectively in the separator T3 and the lithium metallic foil T4 at positions which match with each other. While a silicon-containing active material is meant to act as a negative active material in this embodiment, when combined with a lithium metallic foil which serves as the opposite electrode, acts as the positive active material. However, this does not affect an experiment which aims at identifying the coefficient of expansion n, since a silicon-containing active material, whether used as the negative electrode or the positive electrode, does not change the process of occluding and releasing lithium ions.

As shown in FIG. 4C, the test piece T0 thus obtained is connected to and charged and discharged by a charge-discharge tester T5, the active material lines T2 are observed in situ via the small holes T31 and T41 under a laser microscope for instance, and the dimension of the lines is measured. In this way, the line width We in the charged state and the line width W in the uncharged state can be identified and the coefficient of expansion n can be obtained. The method of calculating the coefficient of expansion n is not limited to this. Other method may be used instead as long as it is possible to compare the line width in the charged state with the line width in the uncharged state.

The inventors of the invention performed the experiment described below, for the purpose of identifying a condition which allows to form an electrode which exhibits an excellent charge-discharge cycle characteristic using an active material whose volume greatly changes during charging and discharging. In the experiment, a plurality of active material patterns having different compositions (and hence different coefficients of expansion n) were created in various dimensions and their charge-discharge cycle characteristics were evaluated.

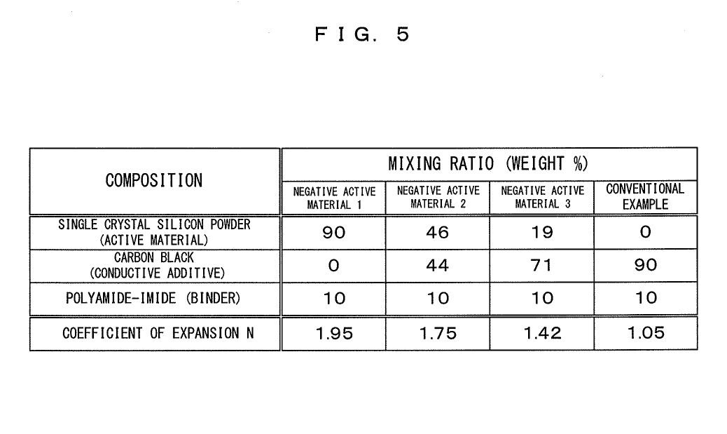

FIG. 5 is a drawing which shows some examples of the relationship between the compositions of the active material patterns and the coefficients of expansion. As the active material, single crystal silicon power was used and polyamide-imide was added as a binder. The resultant mixture was kneaded with an NMP solvent, and the liquid thus obtained was used as an application liquid. Further, carbon black was added as a conductive additive, changing the content rate of the active material in the active material patterns.

In case of the negative active material 1 which is one of the examples, single crystal silicon power accounted for 90 wt % (or mass %) while polyamide-imide accounted for 10 wt % of the solid content excluding the solvent, and carbon back was not added. The coefficient of expansion n was 1.95. This means that the line width W nearly doubles because of charging.

In case of the negative active material 2, 44 wt % of carbon back was added, which made single crystal silicon power 46 wt %. Polyamide-imide was contained at 10 wt %. As the content of silicon which would greatly change its volume was reduced, the coefficient of expansion n became 1.75 which was smaller than that of the negative active material 1. In case of the negative active material 3 in which the content of single crystal silicon powder was further reduced to 19 wt % so that carbon black became 71 wt % and polyamide-imide became 10 wt %, the coefficient of expansion n was 1.42.

Carbon-containing active materials which are currently commercially available correspond to what is described in FIG. 5 as “CONVENTIONAL EXAMPLE” in which the silicon content was zero so that carbon black (or more generally, graphite) would function as an active material. The coefficient of expansion n was 1.05 approximately which was sufficiently smaller than those of the silicon-containing active materials. The charge-discharge cycle characteristic was therefore favorable.

Although the coefficient of expansion n becomes small when the silicon content in the negative active material is reduced, this decreases the amount of lithium which can be occluded and therefore the capacity as an electrode. In contrast, although an increased silicon content increases the charge-discharge capacity, the coefficient of expansion n becomes large and a decrease of the capacity with time due to expansion and contraction during charge-discharge cycles could become a problem. It is possible to solve the problem as stress is mitigated and a decrease of the capacity is suppressed when the active material layer is formed to have a line-and-space structure. However, an increase of the distances between the active material lines in an effort to absorb expansion reduces in essence the amount of the active material and decreases the capacity itself.

Thus, when an active material whose volume greatly changes during charging and discharging is used, there is trade-off that importance placed on the cycle characteristic decreases the capacity while an attempt to increase the capacity deteriorates the cycle characteristic. A condition has not nevertheless been established for attaining both a high capacity and an excellent charge-discharge cycle characteristic.

The inventors discovered through the experiment described below that an appropriate combination of the coefficient of expansion n of an active material and the line dimensions of the active material (the line width W and the line gap S) would make it possible to fabricate an electrode having both a high capacity and a charge-discharge cycle characteristic.

In the experiment, negative electrodes were made by the method above, using a plurality of application liquids having different compositions. Separators and positive electrodes were combined with the negative electrodes, thereby obtaining prototype 2032 coin batteries, and the charge-discharge cycle characteristics of the batteries were measured. Rolled copper foils having the thickness of 10 μm were used as negative current collectors. While changing the composition of the application liquid and the dimensions, the plurality types of negative electrodes were formed.

LiCoO₂ (LCO) as a positive active material, carbon black as a conductive additive and PVDF as a binder were mixed and kneaded at the weight ratio of 8:1:1, and the mixture was mixed with an NMP solvent. The resulting application liquid was uniformly applied to a rolled aluminum foil having the thickness of 20 μm using a blade coater and dried, and what was obtained as a result was used as the positive electrode. A PP sheet was used as a separator, and an EC/DEC mixture in which LiPF₆ at 1 mol/dm³ was dissolved was used as an electrolyte liquid.

The charge-discharge cycle characteristics were evaluated as ten cycles of charging and discharging were performed at the temperature of 25 degrees Celsius, the rate of 0.1 C and the cut-off voltage of 0 through 2.0V (full cell), the discharge capacity in each cycle was measured and the capacity maintaining rate was calculated which was defined by the equation below:

(Capacity maintaining rate)=(Discharge capacity in 10th cycle)/(the discharge capacity in 1st cycle)×100 [%] (Formula 2).

Some of the results will now be described.

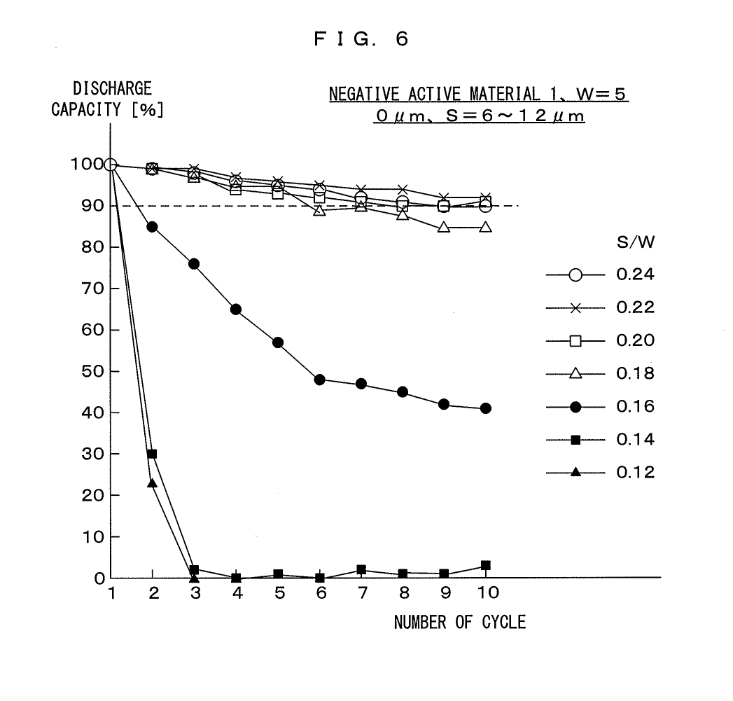

FIG. 6 is a drawing which shows an example of changes in the discharge capacity during charge-discharge cycles. Using the negative active material 1 shown in FIG. 5, active material patterns were formed while changing the line gap S and fixing the line width W at a constant width (50 μm), thereby obtaining samples for this example. FIG. 6 shows the discharge capacity in each charge-discharge cycle from the initial capacity of 100%, together with the ratio (S/W) of the line gap S to the line width W as a parameter. The range of the line gap S was from 6 μm (S/W=0.12) to 12 μm (S/W=0.24).

The trend in FIG. 6 is that when the ratio S/W of the line gap S to the line width W is relatively high, the discharge capacity changes a little from one cycle to the next, whereas when the ratio becomes low beyond a certain extent, the discharge capacity sharply declines from one cycle to the next. In this experiment, a sample in which the capacity in the tenth cycle was 90% or more of the initial capacity was determined as a good sample and a condition for obtaining a good sample was sought.

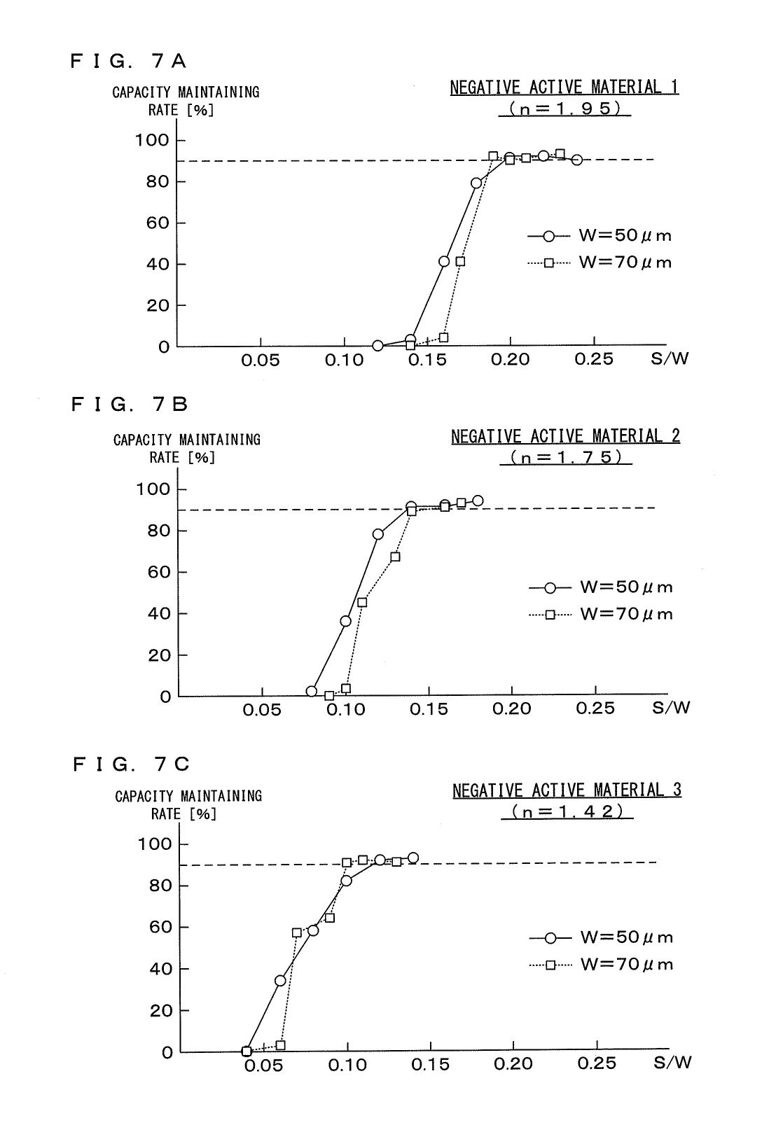

FIGS. 7A through 7C are drawings which show examples of test results. FIG. 7A is a drawing which shows a relationship between the ratio S/W of the line gap S to the line width W and the capacity maintaining rate after ten cycles when the negative active material 1 was used, for which measurements were taken while varying the line gap S and using two types of the line width W of 50 μm and 70 μm. FIGS. 7B and 7C show the results which were obtained using the negative active material 2 and the negative active material 3, respectively, in the same experiment.

It is understood from these results that the capacity maintaining rate is low in the region where the ratio S/W of the line gap S to the line width W is low, and as the ratio S/W increases beyond a certain extent, the capacity maintaining rate sharply increases and an excellent charge-discharge cycle characteristic is achieved. The point at which the capacity maintaining rate rises is different depending upon the active material: the smaller the coefficient of expansion n is, the lower the ratio S/W is when the capacity maintaining rate increases. That is, when the ratio S/W remains the same, the smaller the coefficient of expansion n is, the better the cycle characteristic is. Hence, when the line width W stays the same, the smaller the coefficient of expansion n is, the narrower the line gap S can become. This seems to prove that only small spaces for line expansion are necessary since the lines expand only a little.

Further, while the same trend is seen on the same material regardless of the line width W, those having the narrow line width W show somewhat early rises (shifting toward the left side in the drawing). This is considered to be because when the line width W is wide, expansion-induced stress grows within one line and exceeds absorption, and the line gets easily destroyed.

The ratio S/W of the line gap S to the line width W, the expansion of coefficient n and the capacity maintaining rate is thus related to each other. Based on the relation, a condition for obtaining a good sample in which the capacity maintaining rate is 90% or higher after ten cycles was understood to be favorably approximated by the formula below:

S/W≧n²/20 (Formula 3).

An attempt to increase the left side in (Formula 3) increases spaces between the lines on the current collector and decreases the amount of the active material contributing to charging and discharging. For the purpose of securing the initial capacity, it is preferable to make sure that the line gap S, even when largest, is smaller than the line width W, i.e., that the left side is smaller than one. In the meantime, an attempt to decrease the right side despite use of a material which greatly changes its volume even when alone also reduces the amount of the active material, since it is necessary to decrease the content of the active material by means of addition of a conductive additive agent or the like. These attempts lead to a decrease of the initial capacity. Therefore, it is preferable to choose a condition which is close to the equal sign in (Formula 3) for achieving both a high capacity and an excellent charge-discharge cycle characteristic.

From above, it is seen that the following manufacturing process for instance may be executed to manufacture an electrode for lithium-ion secondary battery which has a high capacity and exhibits an excellent charge-discharge cycle characteristic using an active material which greatly changes its volume due to charging and discharging such as a silicon-containing active material.

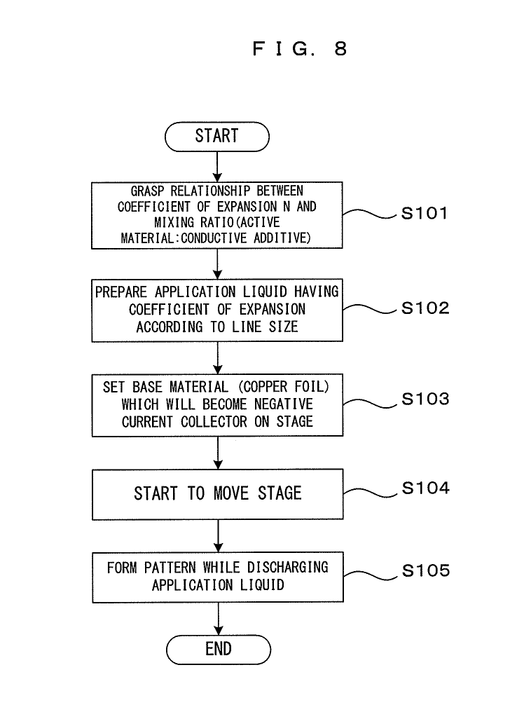

FIG. 8 is a flow chart which shows an embodiment of the electrode manufacturing process. The assumption here is that the dimensions of active material lines have already been set and an electrode which has both a high capacity and an excellent cycle characteristic is to be manufactured while satisfying a design condition for the dimensions. First, with respect to the active material to use, the relationship between the coefficient of expansion n and a mixing ratio of mixing additives such as a conductive additive is grasped (Step S101). When the relationship between the coefficient of expansion n and the composition of the active material is known from a past experiment, literature or the like for instance, the known information may be used. The materials are mixed at a mixing ratio which achieves the coefficient of expansion n which satisfies the condition expressed by (Formula 3) described above in light of the dimensions determined based upon the finding, and the application liquid is prepared (Step S102). Spreading of the application liquid after discharged is dependent upon the viscosity of the application liquid, and therefore, it is possible to adjust spreading in accordance with the amount of a solvent which is added to the application liquid.

The application liquid obtained in this manner is applied to the electrode manufacturing apparatus 20 shown in FIG. 2A for example, and the negative electrode is manufactured. Describing more specifically, a metallic foil such as a copper foil which will become the negative current collector 11 is set to the movable stage 22 of the electrode manufacturing apparatus 20 (Step S103), and the movable stage 22 is moved by the stage drive mechanism 23 (Step S104). In this condition, the application liquid prepared as described above is discharged from each outlet 211 formed in the nozzle unit 21, thereby forming the active material pattern (Step S105). It is thus possible to manufacture an electrode which has both a high capacity and a favorable charge-discharge cycle characteristic at an excellent productivity.

When any one of the width W and the gap S of the active material lines can be freely set, it is possible to form the lines having the width W and the gap S of the active material lines which satisfy (Formula 3) described above in accordance with the physical property of the application liquid which has been prepared in advance or which is appropriately prepared. This also allows manufacturing an electrode which has both a high capacity and a favorable charge-discharge cycle characteristic.

While the electrode manufacturing apparatus 20 shown in FIG. 20A is an apparatus which applies the application liquid to the negative current collector 11 which is like a sheet having predetermined dimensions and accordingly manufacture the negative electrode 10. On the other hand, it is also possible to manufacture the electrode using a manufacturing apparatus of the so-called roll-to-roll type for instance described below, which is a more suitable example to mass production.

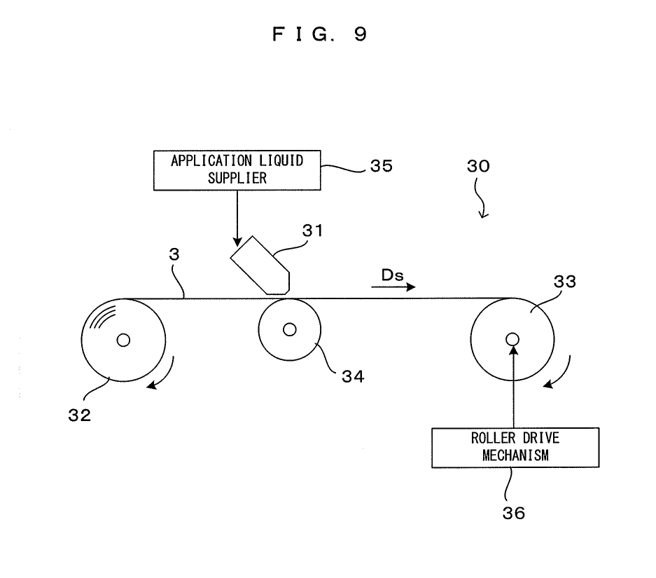

FIG. 9 is a drawing which shows other example of the structure of the electrode manufacturing apparatus. This electrode manufacturing apparatus 30 comprises a supply roller 32 for holding a long sheet-like material 3, which is wound like a roll and is as it is before forming the active material, and for feeding the sheet-like material 3 at a constant speed, and a winding roller 33 which winds up the sheet-like material 3 in which the active material layer has been formed. As a roller drive mechanism 36 drives them into rotations, the sheet-like material 3 is transported at a constant speed in a predetermined transportation direction Ds. The sheet-like material 3 functions as a current collector in the completed electrode, and a metallic foil may be used as the sheet-like material 3 for instance. A resin sheet for example may further be used as a lining, for easier transportation.

On a transportation path from the supply roller 32 to the winding roller 33, a nozzle unit 31 is disposed opposed to the surface of the sheet-like material 3. The structure of the nozzle unit 31 may be the same as that of the nozzle unit 21 described earlier. To the nozzle unit 31, the application liquid prepared to have a proper composition is supplied from an application liquid supplier 35.

Receiving the supply of the application liquid containing the active material from the application liquid supplier 35, the nozzle unit 31 applies the application liquid onto the surface of the sheet-like material 3. A nozzle-facing roller 34 which is disposed on the opposite side of the sheet-like material 3 to the nozzle unit 31 functions as a back-up roller which maintains the relationship between the position of the nozzle unit 31 and that of the sheet-like material 3 and accordingly realizes stable application.

Even when the electrode manufacturing apparatus 30 having the structure above is used, as the relationship between the coefficient of expansion n of an active material line to be formed and the dimensions (the line width W and the gap S) of the active material line is ensured to satisfy (Formula 3), it is possible to manufacture an electrode which has both a high capacity and an excellent charge-discharge cycle characteristic.

As described above, in the embodiment above, the negative current collector 11 corresponds to the “base member” and the “base material” of the invention. In the electrode manufacturing apparatus 20 shown in FIG. 2A, the movable stage 22 functions as the “holder” of the invention and the stage drive mechanism 23 functions as the “mover” of the invention. Meanwhile, in the electrode manufacturing apparatus 30 shown in FIG. 9, the sheet-like material 3 corresponds to the “base material” of the invention, the rollers 32 through 34 function as the “holder” of the invention and the roller drive mechanism 36 functions as the “mover” of the invention.

Note that the invention is not limited to the above embodiment and various changes other than the above can be made without departing from the gist thereof.

For example, although the embodiments above use single crystal silicon powder as the negative active material, besides this, amorphous silicon or a silicon compound such as SiO and SiOC may be used. The structure above of the electrode for lithium-ion secondary battery is effective in realizing both a capacity and a cycle characteristic not only when such a silicon-containing active material is used but also when other active material whose volume changes greatly during charging and discharging is used.

Further, while the mixing ratio of the binder is constant and the mixing ratio of the conductive additive to the active material is changed to various values in case of the negative active material according to the embodiments above, the mixing ratio of the binder may also be changed. The types of the conductive additive and the binder are not limited to those described above.

The cross sectional shape of the active material lines according to the embodiments above is merely one example and not limiting: any desired cross sectional shape may be used. In addition, the shape of opening of the outlets provided in the nozzle unit is not limited to the rectangle according to the embodiments above. Various shapes of opening may instead be used.

In the present invention, the shape of opening of the plurality of outlets may be the same and the outlets may be arranged at constant intervals in the direction of the arrangement, for instance. This allows forming the plurality of active material lines having the same shape of opening in the surface of the base material at constant intervals, and aligning the expansion-contraction behaviors of the active material lines during charge-discharge cycles and accordingly stabilizing the performance.

Further, for example, the gap between the neighboring active material lines in the width direction which is orthogonal to an extending direction of the active material lines may be narrower than the width of the active material lines in the width direction. Although the margin of expansion of the active material increases when the gap between the active material lines is increased, this reduces the amount of the active material per unit surface area as the electrode and hence decreases the capacity. According to the findings by the inventors, since the amount of expansion of a silicon-containing active material during charging is approximately twice at maximum, it is wasteful to provide wider gap than the width of the active material lines. When narrower gap than the line width is provided, it is possible to manufacture an electrode for battery exhibiting a capacity and a cycle characteristic which are balanced as a battery.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A method of manufacturing an electrode for lithium-ion secondary battery, comprising the steps of:
arranging a nozzle unit in which a plurality of outlets are formed in a row along a predetermined arrangement direction and a base material which functions as a current collector in such a manner that each outlet is opposed to and in a vicinity of a surface of the base material; and
discharging an application liquid containing particles of silicon or a silicon compound serving as an active material from each outlet while moving the nozzle unit relative to the base material along the surface of the base material in a direction which intersects the arrangement direction of the outlets, thereby forming within the surface of the base material a stripe-like active material pattern including a plurality of active material lines which are spaced apart from each other and protrude beyond the surface of the base material.

2. The method of manufacturing an electrode for lithium-ion secondary battery of claim 1, wherein a relationship below is satisfied:
S/W≧n²/20
where the symbol W denotes a width of the active material lines at a half height which is half a height of apices of the active material lines measured from the surface of the base material, the symbol S denotes a gap between neighboring active material lines at the half height, and the symbol n denotes a coefficient of expansion which is defined as a ratio of a width of the active material lines at the half height in charged state to a width of the active material lines at the half height in uncharged state.

3. The method of manufacturing an electrode for lithium-ion secondary battery of claim 1, wherein the plurality of outlets have equal shapes of opening to each other, and an arrangement pitch of the outlets in the arrangement direction is constant.

4. The method of manufacturing an electrode for lithium-ion secondary battery of claim 1, wherein a gap between the active material lines in a width direction which is orthogonal to an extending direction of the active material lines is narrower than a width of the active material lines in the width direction.

5. The method of manufacturing an electrode for lithium-ion secondary battery of claim 1, wherein the application liquid is discharged from the outlets whose width of opening in a width direction which is orthogonal to an extending direction of the active material lines is narrower than a width of the active material lines in the width direction.

6. The method of manufacturing an electrode for lithium-ion secondary battery of claim 1, wherein the application liquid contains a conductive additive.

7. The method of manufacturing an electrode for lithium-ion secondary battery of claim 2, wherein the application liquid contains a conductive additive and the coefficient of expansion is controlled as a ratio of mixing the conductive additive to the active material is adjusted.

8. A method of manufacturing an electrode for lithium-ion secondary battery, comprising the steps of:
arranging a nozzle unit in which a plurality of outlets are formed in a row along a predetermined arrangement direction and a base material which functions as a current collector in such a manner that each outlet is opposed to and in a vicinity of a surface of the base material; and
discharging an application liquid containing an active material from each outlet while moving the nozzle unit relative to the base material along the surface of the base material in a direction which intersects the arrangement direction of the outlets, thereby forming within the surface of the base material a stripe-like active material pattern including a plurality of active material lines which are spaced apart from each other and protrude beyond the surface of the base material,
wherein a relationship below is satisfied:
S/W≧n²/20
where the symbol W denotes a width of the active material lines at a half height which is half a height of apices of the active material lines measured from the surface of the base material, the symbol S denotes a gap between neighboring active material lines at the half height, and the symbol n denotes a coefficient of expansion which is defined as a ratio of a width of the active material lines at the half height in charged state to a width of the active material lines at the half height in uncharged state.

9. The method of manufacturing an electrode for lithium-ion secondary battery of claim 8, wherein the application liquid contains particles of silicon or a silicon compound serving as the active material.

10. The method of manufacturing an electrode for lithium-ion secondary battery of claim 8, wherein a gap between the active material lines in a width direction which is orthogonal to an extending direction of the active material lines is narrower than a width of the active material lines in the width direction.

11. The method of manufacturing an electrode for lithium-ion secondary battery of claim 8, wherein the application liquid is discharged from the outlets whose width of opening in a width direction which is orthogonal to an extending direction of the active material lines is narrower than a width of the active material lines in the width direction.

12. The method of manufacturing an electrode for lithium-ion secondary battery of claim 8, wherein the application liquid contains a conductive additive and the coefficient of expansion is controlled as a ratio of mixing the conductive additive to the active material is adjusted.

13. An electrode for lithium-ion secondary battery, comprising:
a base member which functions as a current collector; and
an active material layer formed in a surface of the base member as a stripe-like pattern including a plurality of active material lines which contain silicon or a silicon compound as an active material, which are spaced apart from each other and which protrude beyond the surface of the base member.

14. The electrode for lithium-ion secondary battery of claim 13, wherein a relationship below is satisfied:
S/W≧n²/20
where the symbol W denotes a width of the active material lines at a half height which is half a height of apices of the active material lines measured from the surface of the base material, the symbol S denotes a gap between neighboring active material lines at the half height, and the symbol n denotes a coefficient of expansion which is defined as a ratio of a width of the active material lines at the half height in charged state to a width of the active material lines at the half height in uncharged state.

15. An electrode for lithium-ion secondary battery, comprising:
a base member which functions as a current collector; and
an active material layer formed in a surface of the base member as a stripe-like pattern including a plurality of active material lines which contain silicon or a silicon compound as an active material, which are spaced apart from each other and which protrude beyond the surface of the base member,
wherein a relationship below is satisfied:
S/W≧n²/20
where the symbol W denotes a width of the active material lines at a half height which is half a height of apices of the active material lines measured from the surface of the base material, the symbol S denotes a gap between neighboring active material lines at the half height, and the symbol n denotes a coefficient of expansion which is defined as a ratio of a width of the active material lines at the half height in charged state to a width of the active material lines at the half height in uncharged state.

16. The lithium-ion secondary battery of claim 13, wherein the plurality of active material lines are parallel to each other and have equal widths to each other, and a gap between neighboring active material lines is constant.

17. The lithium-ion secondary battery of claim 13, wherein the active material lines contain a conductive additive.

18. An apparatus for manufacturing an electrode for lithium-ion secondary battery, comprising:
a nozzle unit in which a plurality of outlets are formed in a row along a predetermined arrangement direction and which continuously discharges from each outlet an application liquid which contains particles of silicon or a silicon compound as an active material;
a holder which holds a base material serving as a current collector in a condition that each outlet is opposed to and in a vicinity of a surface of the base material; and
a mover which moves the nozzle unit and the base material relative to each other such that the outlets move along the surface of the base material.

19. An apparatus for manufacturing an electrode for lithium-ion secondary battery, comprising:
a nozzle unit in which a plurality of outlets are formed in a row along a predetermined arrangement direction and which continuously discharges from each outlet an application liquid which contains an active material;
a holder which holds a base material serving as a current collector in a condition that each outlet is opposed to and in a vicinity of a surface of the base material; and
a mover which moves the nozzle unit and the base material relative to each other such that the outlets move along the surface of the base material,
wherein the application liquid is discharged from each one of the plurality of outlets onto the surface of the base material while moving the nozzle unit and the base material relative to each other, thereby forming a plurality of active material lines which satisfy a relationship below:
S/W≧n²/20
where the symbol W denotes a width of the active material lines at a half height which is half a height of apices of the active material lines measured from the surface of the base material, the symbol S denotes a gap between neighboring active material lines at the half height, and the symbol n denotes a coefficient of expansion which is defined as a ratio of a width of the active material lines at the half height in charged state to a width of the active material lines at the half height in uncharged state.

20. The apparatus for manufacturing an electrode for lithium-ion secondary battery of claim 18, wherein the plurality of outlets have equal shapes of outlets, and an arrangement pitch of the outlets in the arrangement direction is constant.
